(19) United States
(12) Patent Application Publication
(10) Pub. No.: US 2019/0266843 A1
(43) Pub. Date: Aug. 29, 2019

(54) Electrical Computers and Digital Processing Systems Involving Interprogram or Interprocess Communication for Risks in a Combined Booked and Pari-Mutuel Environment

(71) Applicant: CFPH, LLC, New York, NY (US)

(72) Inventors: Lee Amaitis, Las Vegas, NV (US); Kenneth L. Miller, Las Vegas, NV (US)

(21) Appl. No.: 16/291,593

(22) Filed: Mar. 4, 2019

Related U.S. Application Data
(63) Continuation of application No. 13/762,795, filed on Feb. 8, 2013, now abandoned.

(51) Int. Cl. G07F 17/32

(52) U.S. Cl. CPC G07F 17/3258; G07F 17/3272

(57) ABSTRACT

An interaction and/or combined efforts of a pool and a book may provide an increased flexibility over a traditional book of wagers and a traditional pool of wagers. Various examples of accepting and forming one or more wagers by a book and a pool are described that enhance the ability to make wager related offers to wagerers.

### CROSS-REFERENCE TO RELATED APPLICATIONS

This application is a continuation of U.S. patent application Ser. No. 13/762,795 filed Feb. 8, 2013, which is incorporated by reference herein in its entirety.

### FIELD

Some embodiments relate to gaming and/or wagering.

### BACKGROUND

Operators may offer one or more wagers to one or more players. Such wagers may include, for example, wagers on races or other events.

### BRIEF DESCRIPTION OF THE FIGURES

FIG. 1 shows an example method that may be performed in some embodiments.

FIG. 2 shows one or more systems that may interact with one another in some embodiments.

### SUMMARY

A. An apparatus comprising: a processor; and a non-transitory medium having stored thereon a plurality of instructions that when executed by the processor cause the apparatus to: receive a request for a first wager on an event from a first user; form the first wager between the first user and a book of wagers; in response to receiving the request, determine at least a portion of the first wager to place with a pari-mutuel pool of wagers; in response to determining the at least the portion, form a second wager defined by the at least the portion of the first wager with the pool to create the second wager between the book and the pool; resolve the first wager with the first user based on an outcome the event; and resolve the second wager with the pool based on the outcome of the event.

A.1.The apparatus of claim A, in which the at least the portion includes less than all of the first wager. A.2. The apparatus of claim A, in which the apparatus is caused to: in response to forming the first wager, providing a rebate to the first user from portions of wagers placed with the book that are not placed with the pool. A.2.1. The apparatus of claim A.2, in which a size of the rebate is based on a characteristic of the wager established to incentivize a particular type of wagers. A.3. The apparatus of claim A, in which the apparatus is caused to: at the end of a wagering period for the pool after the first wager is formed, receiving an indication of odds for the second wager; and setting odds for the first wager to match the odds for the second wager. A.4. The apparatus of claim A, in which the pool includes a totalizator that provides pari-mutuel wagering functionality to customers of the book and other customers.

A.5. The apparatus of claim A, in which the apparatus sis caused to: unpack the first wager into subwagers; and in which the at least the portion includes at least a part of less than all of the subpart. A.5.1. The apparatus of claim A.5, in which the first wager includes a win-place-or-show wager and the at least the portion includes at least a part of only the show part of the win-place-or-show wager. A.6. The apparatus of claim A, in which placing in the pool includes forming the second wager. A.7. The apparatus of claim A, in which a size of the at least the portion is determined based on a riskiness of the first wager such that a larger portion is determined for more risky wagers. A.8. The apparatus of claim A, in which the apparatus is caused to: determine whether any of the first wager should be placed in the pool; and in which determining the at least the portion is performed in response to determining that at least some of the first wager should be placed in the pool. A.9. The apparatus of claim A, in which the book of wagers includes a race and sportsbook. A.10. The apparatus of claim A, in which resolving the first wager includes at least one of: making a payment, crediting an account, transmitting information identifying an outcome of the first wager, and setting a status of the first wager in a data structure. A.11. The apparatus of claim A, in which resolving the second wager includes at least one of: receiving a payment, accepting money into an account, receiving information identifying an outcome of the second wager, and setting a status of the second wager in a data structure.

B. An apparatus comprising: a processor; and a non-transitory medium having stored thereon a plurality of instructions that when executed by the processor cause the apparatus to: receive a request for a first wager on an event from a first user; determine whether any of the first wager should be placed in a pari-mutuel pool of wagers; if it is determined that at least some of the first wager should be placed in the pool: form the first wager between the first user and a book of wagers; determine at least a portion of the first wager to place with a pool of wagers; in response to determining the at least the portion, form a second wager defined by the at least the portion of the first wager with the pool to create the second wager between the book and the pool; resolve the first wager with the first user based on an outcome the event; resolve the second wager with the pool based on the outcome of the event; if it is determined that none of the first wager should be placed in the pool: form the first wager between the first user and the book of wagers; and resolve the first wager with the first user based on the outcome the event.

B.1.The apparatus of claim B, in which determining whether any of the first wager should be placed in the pool includes determining whether the first wager includes a level of risk that is too large to keep with the book based on a risk profile of the book.

C. A method comprising: receiving, by a computing device, a request for a first wager on an event from a first user; forming, by the computing device, the first wager between the first user and a book of wagers; in response to receiving the request, determining, by the computing device, at least a portion of the first wager to place with a pari-mutuel pool of wagers; in response to determining the at least the portion, forming, by the computing device, a second wager defined by the at least the portion of the first wager with the pool to create the second wager between the book and the pool; resolving, by the computing device, the first wager with the first user based on an outcome the event; and resolving, by the computing device, the second wager with the pool based on the outcome of the event.

### DETAILED DESCRIPTION

Some embodiments may enable users to wager on the outcome of one or more events. For example, such wagers may include who will win a race (e.g., a horse race, a dog race, a human race, a car race, etc.), who will win a jai alai game, which team will win a match or tournament, and so on. Some events and or wagers may include (but are not limited to) events and/or wagers that are typically tied to pari-mutuel wagering. Some example events may include a wager related to auto racing, baseball, basketball, boxing, football, golf, hockey, poker tournaments, political races, weather, bingo, keno, any propositions, horse racing, and so on.

Some embodiments may include a pool of wagers. Some embodiments may include an event for which there is a pari-mutuel wagering option. Such an option may be provided by an entity engaging in or providing a system, method, or other functionality described herein and/or some other entity. Pari-mutuel wagering is well known in the art and may include a form of wagering in which: wagers are placed into a pool with one another and winning wagers split the pool. A totalizator or some other entity, such as an entity providing some or all functionality of one or more embodiments described herein, may provide some or all functionality related to a pari-mutuel pool (e.g., form wagers, maintain pools, determine winners, adjust account, determine payouts, make payouts, determine odds, and so on). One example totalizator that may provide functionality regarding a pari-mutuel pool may include AmTote International of Hunt Valley, Md.

Some embodiments may include a book of wagers. Some embodiments may include an event for which there is a booked wagering option. Such an option may be provided by an entity engaging in or providing a system, method, or other functionality described herein and/or some other entity (e.g., an entity that provides pool functionality and/or another entity). Booked wagering is well known in the art and may include forming a wager in which: wagers are not pooled together but rather each wager is separately placed with the book so that wining wagers are paid from funds of the book based on odds and not from a split of a pool. A race and/or sportsbook or some other entity, such as an entity providing some or all functionality of one or more embodiments described herein, may provide some or all functionality related to a a book of wagers (e.g., form wagers, determine winners, adjust account, determine payouts, make payouts, determine odds, and so on). One example race and/or sportsbook that may provide functionality regarding a book of wagers may include Cantor Gaming of Las Vegas, Nevada.

Some embodiments may include an interaction between a book of wagers and a pool of wagers. Such an interaction may allow for a wager to be split (in reality and/or in effect) between a pool and a book. Such interaction may allow a risk sharing between a book and a pool. Such interaction may allow an increase in functionality to users that may not be available from a book and/or a pool without such interaction. All or part of a first wager may be placed (in reality and/or in effect) into a book of wagers and/or all or part of the first wager may be placed (in reality and/or in effect) into a pool of wagers. In some embodiments, part of the wager may be put into a book and part may be placed (in reality and/or in effect) into a pool. Such placement of a wager may include actually forming a wager or may include forming multiple wagers between one or more entities to effectively place the wagers as desired.

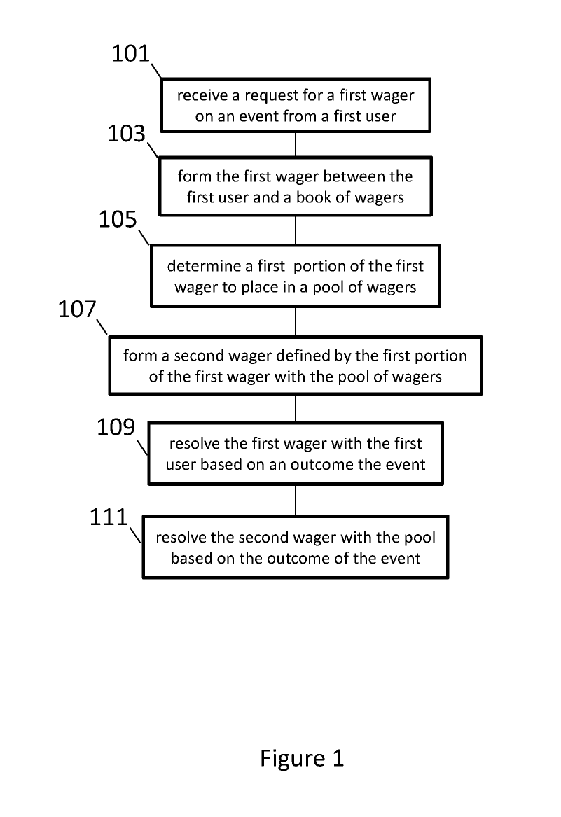

FIG. 1 illustrates an example method that may facilitate an example interaction between a book and a pool and that may be performed in some embodiments. In some embodiments, such a method may be performed by a computer system in part or in whole. In some embodiments, such a method may be performed by an entity that maintains a book and/or an entity that maintains a pool. Such an entity may be a single entity or multiple entities. In some embodiments, such a method may be performed by a third party that neither maintains the book nor the pool.

Some embodiments may include determining one or more wages on one or more events to offer. For example, wagers and/or events for which a pool exists may be offered and/or other wagers may be offered. A pool may be created in some embodiments and then a wager may be offered based on the pool. Events and/or wagers may be chosen based on expected popularity. It should be recognized that any manner of determining wagers and/or events may be used in various embodiments. Offer may include allowing users to place wagers, displaying information about a wager, transmitting data about a wager, populating a user interface about a wager, facilitating placement of and/or request of for a wager, and/or performing any action desired. Some example wagers may include win wagers, place wagers, show wagers, exacta wagers, win-place-or-show wagers, any traditional pari-mutuel wagers, in-running wagers, group wagers, parlays, tournaments, and/or any desired wagers.

Some embodiment may include determining one or more pools. For example, for an upcoming event, a pool for wagers related to the event may be determined. A book (e.g., one performing a method of FIG. 1) may be tied to a single pool provider (e.g., totalizator), may be a pool provider, and/or may use multiple pool providers. For example, each event may have a pool offered through a different pool provider, so that a book may use the pool provider that is associated with a particular event when it offers wagers for that event. If multiple providers offer pools for a same wager and/or event, any pool may be chosen in any manner (e.g., based on cost or relationships with the pools) and/or multiple pools may be used. It should be recognized that any manner of choosing and/or operating a pool may be used in various embodiments.

A book (or other performer of the method of FIG. 1) may open a betting market for one or more events and/or wagers. The betting market may be opened manually and/or automatically in response to reading of a data stream or determination that the event is upcoming. Betting market openings may coincide with pool openings and/or may be at different times than pool openings.

As indicated at 101, some embodiments may include receiving a request for a first wager on an event from a first user. For example, to submit a request, a user may use a computing device to transmit data (e.g., mobile device, a personal computer, a general purpose computer, a kiosk, etc.), a user may submit a request to an operator of a gaming establishment, a user may submit a ticket on which data identifying the wager is entered, a user may enter information into a computer interface, an operator may enter data about the wager into an operator computing device (e.g., at a wagering counter), and/or any other method of requesting a wager may be performed. Such a request may include any information that identifies parameters about the wager, such as a side of a wager, a chosen outcome of an event, an amount of money, and so on.

As indicated at 103, some embodiments may include forming the first wager between the first user and a book of wagers. Such a forming may be performed in response to receiving the request, in response to forming a second wager, in response to determining odds, and/or in response to any other action as desired for a particular embodiment. Forming a wager may include accepting a request, maintaining information about the wager, providing information about the wager to the user, and s/or any other actions. A user may at the end of the forming have a wager between him and the book.

In some embodiments before a request is accepted, a second wager, discussed below may be determined and/or formed with a pool. In response to forming the second wager, the first wager may be formed in such an embodiment. The request by a user to form a wager may not be revocable until either accepted or reject by the book so that the book is not left with a wager with the pool but no wager with the user. Such locking and accepting and forming may take place in near real time in some embodiments to minimize delay and risk to a user and/or book.

In some embodiments, odds of the wager are set at the time of the end of the pool when the pool odds are set. Accordingly, the wagers may have odds that float based on the pool odds. In other embodiments, the odds may be set before then such as when the wager is placed with the book. Setting odds before they are set by the pool may impose an added element of risk to the book because odds for the second wager may change after the first wager is formed. In some embodiments, the actual formation of the first wager does not occur until after the pool sets its odds. At that time all requested wagers with the book may be formed to have matching odds. Money may be held with the book until such time and then used to form the wagers.

As indicated at 105, some embodiments may include determining a first portion of the first wager to place in the pool of wagers. Such a determination may be performed in response to receiving th request, in response to forming the first wager, in response to determining a desire to put a portion of the first wager in the pool, and/or in response to any other action as desired in a particular embodiment. For example, in some embodiments, a percentage of a bet may be determined to go to the pool. The percentage may be a flat percentage for all bets. As another example, in some embodiments different portions may be determined for wagers that have different characteristics. A more risky a wager may go entirely into the pool and/or have a greater portion put into the pool. A less risky wager may have a larger portion or may be entirely kept by the book.

For example a 100 dollar show bet could send 96 to the pool and keep 4 booked. As another example, a book could book 2% of all or some bets (e.g., some less risk bets not exacta bets, not parlay bets). As yet another example, a book could keep all or portions of some show bets (or bets of a desired type that are generally considered safer than other bets or have any desired characteristics). A book could send all or larger portions of all or some exacta bets (or bets of a desired type that are generally considered riskier than other bets or have any desired characteristic). As still another example, in some embodiments, a first wager may be unpacked into constituent wagers and those wagers may be in part or in whole placed into the pool and/or kept in a book. For example, a win-place-or-show bet is effectively three bets: a win bet, a place bet, and a show bet. Some embodiments may include placing the win and place bet into the pool and keeping (at least part of and maybe all of) the show bet in the book.

In some embodiments, all wagers may be placed in the pool in their entirety. In some embodiments, some may be placed in the pool in their entirety and some may in their entirety or in part be booked. In some embodiments some may be part in the pool and part in the book. It should be recognized that even though some examples discussed a part booked and part pooled wager, that any combination or treatment of wagers may be used in various examples. Some embodiments may include determining whether to place part, some, and/or or all of the wager into the pool and/or into the book based on some desired risk characteristic or other characteristic of the wager. A determination of the portion to be placed in the pool and/or the book may be made in response to a determination that a wager portion should be placed therein.

Although examples have been given in terms of a wager being formed in its entirety between the book and the user such example is non-limiting. Some embodiments may include determining a portion of the first wager to place in a book of wagers. The portion may include the rest of the wager in some embodiments. The portion may include less than the rest of the wager in other embodiments. Further portions may be placed in any manner such as with other pools or other books or other entities in any combination as desired. Various examples of such portioning and pass through wagers are given elsewhere herein.

As indicated at 107, some embodiments may include forming a second wager with the pool of wagers. The second wager may be defined by the first portion of the first wager. Such a formation may be performed in response to determining the portion in some embodiments. The second wager may be formed between the book (which may be the operator thereof) and the pool (which may be the operator thereof). The second wager may be placed in the pool. For example, if 96 dollars of a 100 dollar win wager are determined to be put into the pool, a wager between a book and a pool for 96 dollars on the win may be formed thereby placing a 96 dollar win wager by the book in the pool. In some embodiments, any wager that is defined by the first portion may be formed between the book and the pool.

Forming a second wager may include transmitting information to the pool to form the wager and/or in any manner entering into a second wager in a manner allowed by a pool operator. For example, the book may have a wagering account with a totalizator and may use that account to form the second wager. Data may be transmitted from the book to the pool instructing the pool to form the second wager. The book may receive a verification of the formed wager. In some embodiments where the first wager is not formed until the second wager is formed, the book may form the first wager in response to receiving such verification.

In some embodiments where an entirety of the first wager is to be placed in the pool, the second wager may be defined by the entirety of the first wager. In some embodiments where an entirety of the first wager is to be kept by the book, no second wager may be formed with the pool at all.

Determinations reading placement into the pool and/or book and/or forming of (first and/or second) wagers may take place nearly simultaneously in some embodiments. Such fast paced actions may limit the amount of risk for a book and/or delay for a customer. Some embodiments may utilize computers to achieve the speed of such actions and/or data transmission. Without such computer technologies some embodiments may not function in a manner that allows customers and books to effectively take actions to make such a method functional.

As indicated at 109, some embodiments may include resolving the first wager with patrons based on an outcome of the event. Such resolving may be performed in response to determining an event outcome (e.g., receiving an indication indicating such an outcome). The odds used to resolve the first wager may be based on track odds and/or pool odds (in other embodiments as discussed above in which odds are set at the time of placement of the first wager rather than when the pool closes, the odds may be the odds set at the time of placement of the first wager). For example, an indication of the outcome may be received (e.g., from the venue hosting the event, from a news source, etc.) and an indication of the final odds of the pool may be received (e.g., from the pool, from a news source, etc.). If the first wager is determined to be a winning wager based on the outcome, the first user may be allocated a payment that is proportional to the pool odds and an amount wagered in the first wager. Determining an amount to allocate to a winning wager based on odds of the wager and an amount wagered is a well-known action in the art and can take many forms. If the first wager is determined to be a losing wager based on the outcome, the first user may not be paid any winning amount. Resolving the first wager may include any actions that may bring about the resolution of the life of the first wager from the perspective of the book (e.g., payment, marking a winning wager, marking a losing wager, transmitting information about a status, recording status of the wager, adjusting an account, etc.).

As indicated at 111, some embodiments may include resolving the second wager with the pool based on the outcome of the event. Such resolving may be performed in response to determining an event outcome (e.g., receiving an indication indicating such an outcome). The odds used to resolve the second wager may be based on track odds and/or pool odds. Such odds may be the same odds used to resolve the first wager (or different odds depending on the embodiment). In some embodiments, resolving the second wager may include any actions that may bring about the resolution of the life of the first wager from the perspective of the book. For example, some embodiments may include receiving money, having an account credited, receiving information indicating that money has been credited or assigned to the book, marking a wager as won or lost, and/or any other actions so that the second wager is resolved. The pool (or pool operator) may take actions to make a payment to the book and the book may receive such money or the right to use such money in an account.

In some embodiments, a rebate may be provided to one or more wagers (e.g., the first user). A rebate may be provided from money from wagers that is booked and not put into the pool. In some embodiments, pooled money may be restricted from use in rebating. In other embodiments, the rebate may be provided from money in the pool or placed into the pool and/or when no such restrictions apply. A rebate may include a portion of a wagered amount that is returned to the wagerer. The rebate may be given to all wagerers, winning wagerers, losing wagerers, wagerers that place certain wagers, etc. The rebate may be given at the time of the wager, after the wager outcome is determined (e.g., as part of resolving the wager, after resolving the wager, etc.) and/or at any other time. A rebate for example may include providing an amount of money to a wagerer by crediting a wagering account.

Some embodiments may include determining whether to provide a rebate and/or an amount of a rebate. A rebate amount may be based on an amount of a wager and/or a characteristic of the wager. For example, the rebate may include a percentage of the wagered amount and/or amount won by the wager. The percentage may vary based on the type and/or amount of the wager. Different types of wager may have different rebates and some wagers may be no rebates at all. A book may desire to incentivize certain types of wager so may apply rebates or higher rebates to those desired wagers. For example, the book may desire to incentivize risky wagers (e.g., exactas) and so may rebate the placement of such wagers but may not rebate or provide lower rebates for less risky wagers (e.g., show wagers). As another example, the book may desire to incentivize larger wagers and so may provide rebates or higher rebates to larger wagers and no rebates or smaller rebates to smaller wagers. It should be recognized that any desired chrematistic may be used to determine whether a rebate should be give and/or how much of a rebate (e.g., time of day, size of wager, type of wager, distance from event start, type of event, location of event, characteristic of the wagerer such as age, income, gender any demographic information). In some embodiments, a same percentage rebate may be applied to all wagers.

A rebate program is just one non-limiting example of a type of incentive program that a book may offer to wagerers. For example, a book may use booked wagers to provide other promotional offers such as free meal, free drinks, a match of a wagered portion, bonus prizes, a loyalty program, and so on.

In some embodiments, a book that operates using a method such as that of FIG. 1 may take on more risk than that of a pool. In some embodiments, a book that operates in such a manner may earn less profit that of a straight book and/or a straight pool per wager. For example, fees may be paid to a venue that hosts an event for each book and each pooled wager on the event. For example, race tracks may charge 3.5 percent of wagers to pool a bet on a race hosted at the race tracks, and race tracks may charge 3 percent to book a bet on a race hosted at the race tracks. So, a charge for a bet that goes first into the book and then into the pool may incur both the charge of 3 and 3.5 percent.

Despite such an increase in risk and/or a decrease in profits per wager, such a method may provide benefits over a traditional book or pool. For example, a traditional pool may not have the ability to offer a rebate and a traditional book may take on more risk than a mixed book and pool. Moreover, a venue may benefit from the increase in fees paid on wagers. Such a method may drive business to the book to allow it to compete against a pool and may minimize risk to allow it to take wagers that other books might not be able to take while supporting venues to a greater degree than traditional book or pool methods.

It should be recognized that while some examples are given in terms of a book performing the method and forming a booked wager with the first user and a wager to offset the booked wager between the book and a pool, that this example is non-limiting. For example, some embodiments may be performed by the pool and do the opposite by forming a pooled wager with the user and then booking apportion of the pooled wager with a book. As another example, some embodiments may include an operator that is both the pool and book operator. In such an example, wagers may be made between separate portions of a same entity rather than different entities. In other such examples, wagers may be split directly with the pool and book with the first user so that the user may end up with two wagers that sum to the first wager: one with the pool and one with the book.

As still another example, some embodiments may allow for a pass through wagering in some or all instances so that a wager or portion thereof may be formed directly to the pool even if the book is performing the method. In such an example, a wager that is received by the book and determined to go completely into the pool may be passed through to the pool directly to form a wager between the pool and the user. In such an example, a wager that is determined to go completely into the book may be formed directly with the book and the user. In such an example, a wager that is determined to be part booked and part pooled may act as described above in which a first wager is formed with the book and user and a second wager is formed with the book and pool or may act in an alternative in which a wager between the book and user is formed and a wager between the pool and user is formed to sum to the first wager. Such pass through or multiple wager forming with the first user may make the wagering cheaper on the provider by reducing venue fees.

Some discussion may refer to a pool or book and/or a pool operator/provider or revenue operator/provider. A reference to a pool may refer to the pool operator/provider and/or the actual pool of wagers maintained by such an operator/provider. A reference to a book may refer to the book operator/provider and/or the actual set of wagers that are maintained by such an operator/provider.

As further examples, some embodiments may be performed by neither a pool or book provider. A third party may operate as a receiver of wagers and may offload the wagers to the pool and/or book in some such embodiments. The third party may make some fee for forwarding the wagers and providing liquidity for wagers. Such a third party may place wagers directly (e.g., pass through) to the pool and/or book in some embodiments.

Although some examples are given in terms of a wager in the book and pool being the same, it should be recognized that some embodiments may include different wager in the pool and book. For example, a pool may include a win and place pool. A book when it receives a win, place, or show wager may place the win and place parts into the pool but keep the different show bet in the book. This may be the case if the pool has or does not have a show pool and thus may allow the book to offer a wager type that the pool might not offer. Any other combination of wagers or additional variations or modifications to pool wagers may be added by the book to enhance the wagering of the book when compared to the pool. By booking a part of the wager that is not available through the pool, the book may thus form new wagers but offload risk of the old wager portion to the pool. A book may determine wages to offer based on available wagers in the pool and augmentations it may add to them to create new types of wagers. A third party in some embodiments may form wagers by combining available booked wagers and pool wages to create a new type of wager that is offered in neither the book nor the poo in some embodiments.

It should be recognized that various examples and embodiments discussed with respect to FIG. 1 are given as non-limiting examples only and that other embodiments may include other actions, different actions, differently ordered actions, different actors, and so on. For example, the pool provider may perform some of the method or a different method rather than a book provider, a cloud service provider may perform some of the method or a different method, and so on. Ordering of the method and steps does not imply that actions must be or are taken in such orders. Separation of actions into method step does not imply that actions are separately taken or separate things and they cannot or do not take place simultaneously or as part of a single action.

### System Examples

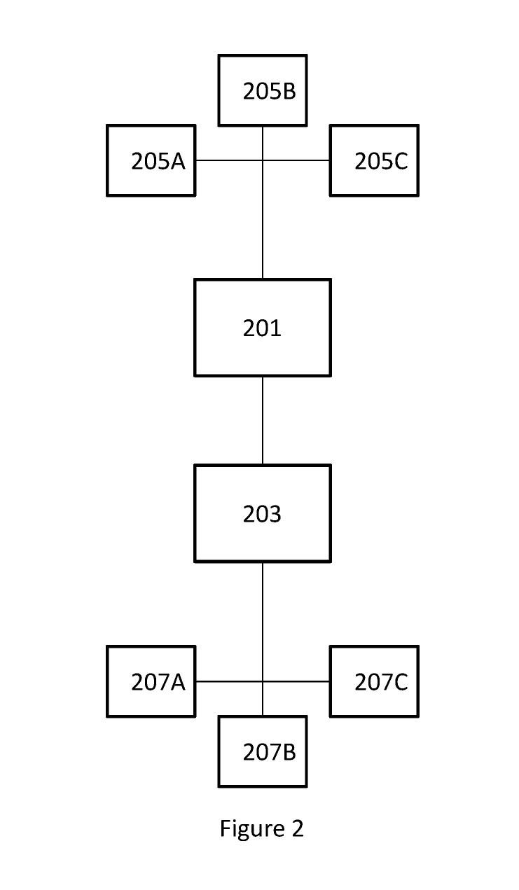

FIG. 2 illustrates an example of one or more systems that may be part of and/or facilitate part of some embodiments. For example, FIG. 2 illustrates a book provider 201, a pool provider 203, book customers 205a-c, and pool customers 207a-c. Each element may include one or more computing devices (e.g., servers, mobile devices, personal computers, processors, module, etc.) that may performs one or more actions to facilitate functionality of a desired embodiment.

In some embodiments, book provider 201 may include a race and/or sportsbook that performs a method of FIG. 1. A computing device (e.g., server, processor) of the book may perform actions to accept wager requests, form wagers with a customer, determine odds, offer wagers, determine portions of a wager to place in a pool, adjust accounts, form wagers with a pool, resolve wagers, and so on.

In some embodiments, pool provider 203 may include a totalizator or other entity that performs actions related to the pool. A computing device (e.g., server, processor) of the pool provider may perform actions to accept wagers (e.g. from its customers and/or the book), form wagers, resolve wagers, adjust accounts, form wager pools, set odds, and so on.

A book and/or pool provider may maintain accounts for one another and/or for their customers. Wagers may be placed from such accounts and resolved into such accounts in some embodiments. Account balances may be adjust based on wager outcomes, withdraws, deposits, rebates, and/or other actions. Some embodiments, rather than and/or in addition to such electronic accounting may include cash based and/or ticket based wager resolution mechanisms associates with a pool and/or book operator.

Customers of the book 205a-c may enter wagers through the book. The wagers may be with the book as described above in some embodiments. For example, customer 205a may include the first user that forms the first wager in the example of FIG. 1. The customers may operate computer devices (e.g., cell phones, processors) to place wagers with the book and/or may place wagers in any manner. The wagers may include a mix of wagers with the book and the pool and/or may include wager with the pool as described above with respect to pass through examples. The book may maintain account information for its customers.

Customers of the pool 207a-c may include customers that place wagers through the pool and/or place wagers into the pool through some other operator other than the book operator. Wagers of theirs may be pooled with wagers entered through the book operator. The customers may place wagers with the pool in any manner. Customers of the pool may also be customers of the book at times. The pool may maintain account information for its customers (which may include the book itself).

One or more networks may allow transmission of data and/or other communication about wagers between customers and the pool, customers and the book, the pool and the book, and so on. For example the Internet, a LAN, and/or any other communication network may allow transmission of payment data to accounts, odds data, wager request, any wager information, and so on. Although shown as separate networks in FIG. 2, it should be understood that the networks may include a single network such as the Internet.

It should be recognized that the example of FIG. 2 is given as a non-limiting example only. Various embodiments may include some or all of FIG. 2 or none of FIG. 2 depending on the details of the embodiment. Other embodiments, for example may include a cloud based system in which the pool and book are cloud services. A wage acceptor and/or portion determiner may also be a cloud service. Such services may be offered by different entities and/or the same entities. As another example, the pool and book may be a same entity. As another example, other elements may be included, such as other books, other pools, bank account providers, and so on.

It should be recognized that various embodiments are described in a non-limiting manner only. Embodiments may be combined in any manner with one another but no portion of any embodiment is required in any other embodiment.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples and Terminology are not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim.. An Abstract has been included in this application merely because an Abstract is required under 37 C.F.R. § 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth □, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

VII. 35 U.S.C. § 112, paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description and enablement in accordance with 35 U.S.C. § 112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

What is claimed is:

1. (canceled)

2. A kiosk comprising:
a memory;
an insert device;
a network interface;
at least one processor to:
receive, via the insert device, a ticket with data indicative of a request from a player for a first wager on an event;
generate, in the memory, data indicative of the first wager between the player and a gaming operator;
in response to receiving the request, identify a proportion of the first wager to place with a pari-mutuel pool of wagers;
generate, in the memory, data indicative of a second wager between the gaming operator and the pari-mutuel pool of wagers, the second wager comprising the proportion of the first wager;
receive, via the network interface, data indicative of an outcome of the event;
resolve the first wager based on the outcome of the event; and
resolve the second wager with the pool based on the outcome of the event.

3. The kiosk of claim 2, in which the at least one processor is further configured to:
display, on a display device, data indicative of a rebate from portions of wagers placed with the gaming operator that are not placed with the pari-mutuel pool of wagers.

4. The kiosk of claim 3, in which a size of the rebate is based on a characteristic of the first wager established to incentivize a particular type of wager.

5. The kiosk of claim 2, in which the at least one processor is further configured to receive, via the network interface, an indication of odds for the second wager; and setting odds for the first wager to match the odds for the second wager.

6. The kiosk of claim 2, in which the pool includes a totalizator that provides pari-mutuel wagering functionality.

7. The kiosk of claim 2, in which the at least one processor is further configured to:
unpack the first wager into subwagers; and
in which the proportion of the first wager includes at least a part of one subwager of the subwagers.

8. The kiosk of claim 7, in which the first wager includes a win-place-or-show wager and the proportion of the first wager includes a show part of the win-place-or-show wager.

9. The kiosk of claim 2, in which placing in the pool includes forming the second wager.

10. The kiosk of claim 2, in which a size of the proportion of the first wager is determined based on a risk of the first wager such that a larger proportion is identified for riskier wagers.

11. The kiosk of claim 2, in which the gaming operator includes a database of wagers on a race and on sports.

12. The kiosk of claim 2, in which to resolve the first wager the at least one processor is configured to execute at least one of: making a payment, crediting an account, displaying information identifying an outcome of the first wager, and setting a status of the first wager in a data structure.

13. The kiosk of claim 2, in which to resolve the second wager the at least one processor is configured to execute at least one of: receiving a payment, accepting money via a cash receiver, receiving information identifying an outcome of the second wager, and setting a status of the second wager in a data structure.
